(19) United States
(12) Patent Application Publication
(10) Pub. No.: US 2024/0071403 A1
(43) Pub. Date: Feb. 29, 2024

(54) METHOD AND SYSTEM FOR VOICE CLARITY DURING TELEPHONIC CONVERSATION

(71) Applicant: INTERNATIONAL BUSINESS MACHINES CORPORATION, ARMONK, NY (US)

(72) Inventors: Sarbajit K. Rakshit, Kolkata (IN); Shailendra Moyal, Pune (IN); Akash U. Dhoot, Pune (IN); Nitika Sharma, Zirakpur (IN)

(21) Appl. No.: 17/822,861

(22) Filed: Aug. 29, 2022

(51) Int. Cl. G10L 21/0216; G10L 25/30

(52) U.S. Cl. CPC G10L 21/0216; G10L 25/30

(57) ABSTRACT

According to one embodiment, a method, computer system, and computer program product for front-end clipping reduction is provided. The embodiment may include initiating an audio interaction. The embodiment may also include predicting a change in network connectivity within the audio interaction. The embodiment may further include, in response to the predicted change in network connectivity, determining whether to perform a voice clarity improvement. The embodiment may also include, in response to determining to perform the voice clarity improvement, performing the voice clarity improvement for the audio interaction.

### BACKGROUND

The present invention relates generally to the field of computing, and more particularly to telephonic telecommunications.

Telephonic telecommunication is a means of live telecommunication that allows users to communicate by audio, including by voice, over large distances. Audio is transmitted over network technologies, including mobile networking technologies, Wi-Fi® (Wi-Fi and all Wi-Fi-based trademarks and logos are trademarks or registered trademarks of the Wi-Fi Alliance and/or its affiliates), and Bluetooth® (Bluetooth and all Bluetooth-based trademarks and logos are trademarks or registered trademarks of the Bluetooth Special Interest Group and/or its affiliates). These audio transmissions allow for audio messaging, real-time voice conversations, live music streaming, teleconferencing, and more.

### SUMMARY

According to one embodiment, a method, computer system, and computer program product for front-end clipping reduction is provided. The embodiment may include initiating an audio interaction. The embodiment may also include predicting a change in network connectivity within the audio interaction. The embodiment may further include, in response to the predicted change in network connectivity, determining whether to perform a voice clarity improvement. The embodiment may also include, in response to determining to perform the voice clarity improvement, performing the voice clarity improvement for the audio interaction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computing environment according to at least one embodiment.

FIG. 2 illustrates an operational flowchart for a process for front-end clipping reduction according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to video conferencing. The following described exemplary embodiments provide a system, method, and program product to, among other things, reduce front-end clipping. Therefore, the present embodiment has the capacity to improve the technical field of video conferencing by improving voice activity detection, and more particularly by reducing front-end clipping.

As previously described, telephonic telecommunication is a means of live telecommunication that allows users to communicate by audio, including by voice, over large distances. Audio is transmitted over network technologies, including mobile networking technologies, Wi-Fi® and Bluetooth®. Since, under real world conditions, network performance and coverage may be inconsistent, the clarity of voices in transmitted audio may, from time to time, suffer.

A network and computer system may use several different techniques to combat a poor connection. For example, a cell phone may warn a user that a connection is poor, or attempt to connect to a different network. Alternatively, a cell phone may use its own microphone instead of a connected wireless microphone with a poor connection. However, these techniques may still be insufficient to achieve a clear conversation. As such, it may be advantageous to improve voice clarity when a connection is poor using Generative Adversarial Networking (GAN) and the Internet of Things (IoT).

According to at least one embodiment, a telecommunication solution may initiate a phone call or other audio interaction. The system may then predict a change in network connectivity based, for example, on the direction in which a party is moving. Upon predicting poor network connectivity, GAN or usage of nearby IoT devices may be enabled or disabled to improve voice clarity.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as voice clarity improvement program 150. In addition to voice clarity improvement program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and voice clarity improvement program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

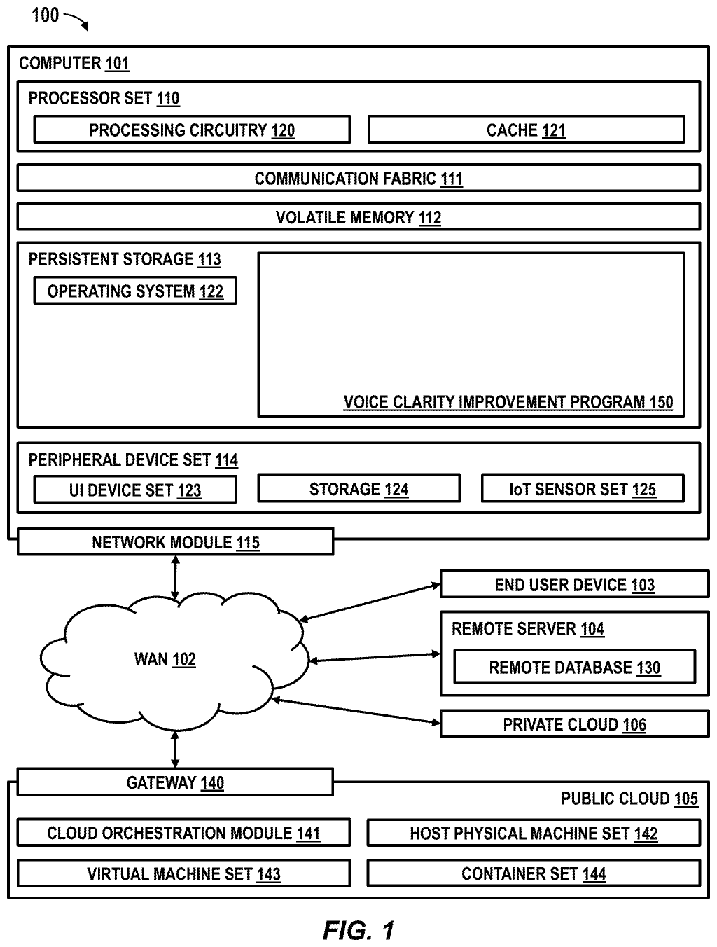

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in voice clarity improvement program 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in voice clarity improvement program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi® network. The WAN 102 and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

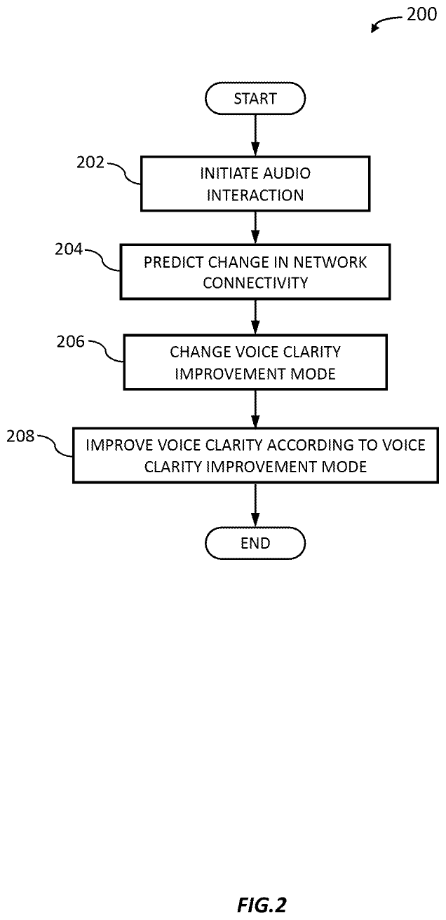

Voice clarity improvement program 150 may be a set of computer instructions that carry out the inventive steps. After initiating an audio interaction the voice clarity improvement program 150 may predict a change in network connectivity. In response to this predicted change, the voice clarity improvement program 150 may select a method of voice clarity improvement, and subsequently improve voice clarity according to the selected method. Notwithstanding depiction in computer 101, voice clarity improvement program 150 may be stored in and/or executed by, individually or in any combination, end user device 103, remote server 104, public cloud 105, and private cloud 106. The method for voice clarity improvement is explained in further detail below with respect to FIG. 2.

Referring now to FIG. 2, an operational flowchart illustrating a process for front-end clipping reduction 200 is depicted according to at least one embodiment. At 202, the voice clarity improvement program 150 initiates an audio interaction. An audio interaction may include a regular phone call, a voice over IP call, a video-and-audio enabled call, an audio-enabled teleconference, an audio message, or a one-way audio-enabled stream, including, for example, a teleconferencing presentation, a music broadcast, or a social media broadcast.

Alternatively, the audio interaction may be initiated by another program, such as a system phone application, a voice over IP application, or a social media application. In at least one embodiment, the audio interaction is initiated by a user. A user may initiate an audio interaction, for example, by placing a call, answering a call, or starting a live stream.

In a further embodiment, the audio interaction may involve capturing audio input. Capturing audio input may include recording audio using one or more audio sensors embedded in or communicatively coupled with computer 101, including a peripheral device from peripheral device set 114. An audio sensor may include, for example, a smartphone's microphone array, a microphone on a pair of headphones, or a dedicated peripheral microphone.

In another embodiment, the voice clarity improvement program 150 may determine, by an opt-in procedure, what nearby devices are available for IoT-assisted improvement. Nearby devices may include devices on the same Wi-Fi® network, devices within range of a Bluetooth® connection, or devices within range of a user's voice.

In yet another embodiment, the voice clarity improvement program 150 may capture additional information by an opt-in procedure, including video input, text input, touch input, motion sensor input, the time of the interaction, the location of the general or precise interaction device-identifying data, data about peripheral devices, or data identifying nearby IoT devices.

In at least one embodiment, the voice clarity improvement program 150 may only capture input through input streams that the user chooses to enable through an opt-in procedure. The voice clarity improvement program 150 may offer users an option to disable any input stream, including the visual or audio stream, temporarily or indefinitely, reenable an input stream, or switch one input stream for another. For example, a user may mute a particular microphone, or switch from using a camera embedded in a laptop to a peripheral camera.

Then, at 204, the voice clarity improvement program 150 predicts a change in network connectivity. The change in network connectivity may be an improvement or reduction in network connectivity. Network connectivity may be measured, for example, according to a physical measurement of signal strength between a device and a network or a device and another device, a complex representation of connection strength, or a representation of the fidelity of audio sent from a device as compared to input audio.

In at least one embodiment, predicting may be performed in light of the direction and speed of a device or user. For example, if a device is moving from an area with high signal strength to an area with low signal strength, the voice clarity improvement program 150 may predict a reduction in network connectivity. Alternatively, if a device is approaching a known dead zone, such as an elevator shaft, the voice clarity improvement program 150 may predict a significant reduction in network connectivity.

Predicting may take more than one network or connection into account. For example, predicting may be performed based on movement relative to both a Wi-Fi® connection and a mobile network connection, or based on whichever of the two is expected to be stronger. Predicting may be performed for one or more devices participating in a call. For example, predicting may be performed for signal strengths of a wireless headset and two mobile phones, or once for all of those devices combined.

In an alternate embodiment, predicting may be performed based on measurements of the network itself. For example, predicting may be performed based on physical measurements of the signal strength of a Wi-Fi® Router. In another embodiment, predicting may be performed based on the presence of other devices in range of the network. For example, if a device that was previously consuming large amounts of bandwidth exits a Wi-Fi® network's range, the voice clarity improvement program 150 may predict an improvement in network connectivity.

In yet another embodiment, predicting may be performed based on other factors, including a state of a device, a state of real-world surroundings, or an audio analysis of the call. For example, if a device's battery is low, and there is a feature enabled that will disconnect one network in favor of another network when battery is low, predicting may be performed based on projected battery power and a change in active network. As another example, if a user is standing at an elevator door on the third floor, predicting may be based on a projected time at which the elevator will reach the third floor. As another example, predicting may take into account the overall data transfer rate of a device.

In yet another embodiment, predicting may be performed based on a combination of two or more of the above factors. For example, if a user is approaching a train station, and has recently looked up times for a particular train route, the voice clarity improvement program 150 may predict a significant reduction in network quality during the times when the train, traversing the route, is projected to enter dead zones. As yet another example, if a user places a call on a cell phone in a bedroom with a connected wireless headset, and leaves the phone in the bedroom, heading to the kitchen, and a wall between the kitchen and the bedroom is known to block some amount of wireless signal, the voice clarity improvement program 150 may predict a reduction in network connectivity.

In a further embodiment, predicting may involve a process of machine learning over time based on the audio, the direction in which the device is headed, the device's speed, or the additional information collected at 202 or 206. Machine learning may involve other Artificial Intelligence (AI) or machine learning techniques, such as use of a neural network, to improve predictions over time.

In at least one embodiment, predicting may predict an absolute level of network connectivity. Alternatively, predicting may predict a level of network connectivity relative to a previous level of network connectivity, or relative to a predetermined threshold. A threshold may alternatively be set by a user, for example through a graphical user interface with a sliding measure. Network connectivity may be measured by a physical measurement, an abstract representative measurement of connectivity, a discrete measurement of levels of connectivity, or a binary of good and bad network connectivity.

In at least one embodiment, the voice clarity improvement program 150 may predict continuously over the course of the audio interaction. For example, if Ethan is streaming video from a desktop computer over an inconsistent Wi-Fi® connection, the voice clarity improvement program 150 may predict poor network connectivity two minutes into the stream, predict good network connectivity at five minutes, predict poor network connectivity at 18 minutes, and predict good network connectivity at 28 minutes.

Then, at 206, the voice clarity improvement program 150 selects a voice clarity improvement mode based on the predicted change in network connectivity. Voice clarity improvement modes may include GAN-enabled improvement, and IoT-assisted improvement, combined improvement, and no improvement.

In at least one embodiment, the voice clarity improvement program 150 may select no improvement when network connectivity is predicted to exceed a predetermined threshold. Alternatively, the voice clarity improvement program 150 may select GAN-enabled improvement or IoT-assisted improvement when network connectivity is predicted to go below a predetermined threshold.

In an alternate embodiment, the voice clarity improvement program 150 may select IoT-assisted improvement or combined improvement when network connectivity is predicted to go below a certain threshold and there are nearby devices available for IoT-assisted improvement. For example, if a user makes a call on a phone while a smart speaker is within range of Bluetooth®, and the user has opted into IoT-assisted improvement for each device, the voice clarity improvement program 150 may select IoT-assisted improvement.

In alternate embodiments, the voice clarity improvement program 150 may select voice clarity improvement modes in light of additional information. Additional information may include number of nearby devices available, voice clarity of the input of nearby devices, an algorithmic measurement of the accuracy of GAN, the average effectiveness of GAN for the language the user is speaking, a device state, the nature of the network in use, available bandwidth on the network, mobile plan data limits, or the presence of other sounds on the call. Other sounds may include, for example, music, sounds from nature, or background noise.

In at least one embodiment, the voice clarity improvement program 150 may select different voice clarity improvement modes over time. For example, if Ethan is streaming video from a desktop computer over an inconsistent Wi-Fi® connection, the voice clarity improvement program 150 may select GAN-based improvement two minutes into the stream, select no improvement at five minutes, select combined improvement at 18 minutes, and select no improvement at 28 minutes.

Then, at 208, the voice clarity improvement program 150 improves voice clarity according to the voice clarity improvement mode. Voice clarity improvement may improve comprehensibility of the words a user is speaking, preserve the meaning of a user's speech, preserve the accents and intonation of a user's voice, or fidelity of sounds in general.

In at least one embodiment, GAN-enabled improvement may include improving voice clarity using GAN. For example, GAN may be used to fill words or syllables that would otherwise be missed due to network connectivity issues. GAN may include use of neural networks, including a convolutional neural network and a deconvolutional neural network.

In yet another embodiment, voice clarity improvement may separately involve a process of machine learning over time based on the audio or the additional information collected at 202 or 206, not necessarily as a part of GAN. Machine learning may involve other AI or machine learning techniques, such as use of a neural network.

In a further embodiment, IoT-enabled improvement may include improving voice clarity by obtaining, by opt-in procedure, additional audio input from nearby devices with microphones. For example, if a user makes a call on a phone while a smart speaker is nearby, and the user has opted into IoT-assisted improvement for each device, IoT-based improvement may combine audio streams from both devices and refine the combination to maximize the clarity of the voice. Alternatively, if a user makes a call on a phone while in a vehicle, and the user has opted into IoT-assisted improvement for each device, and the call is primarily using the phone's microphone, IoT-based improvement may utilize the vehicle and its microphone to assist in improving voice clarity.

In at least one other embodiment, combined improvement may include using two or more other methods to improve voice clarity. For example, combined improvement may include using IoT-enabled improvement, and further using GAN-enabled improvement when IoT-enabled improvement alone is not sufficient to achieve satisfactory voice quality. Alternatively, combined improvement may include preparing both IoT-enabled improvement and GAN-enabled improvement, and selecting one prepared improved audio stream based on which one is better at the moment.

In an alternate embodiment, the voice clarity improvement program 150 may, upon predicting that voice improvement is not necessary at a particular time, stop improving voice clarity until such time as the voice clarity improvement program 150 predicts that voice improvement is necessary again.

In an alternate embodiment, voice clarity improvement may also assist with audio latency, normalize audio volume, or improve audio quality. For example, if one IoT device is known to have a high-quality microphone, and the phone call is placed using a pair of headphones with a built-in low-quality microphone that struggles to represent treble notes in speech, IoT-enabled voice clarity improvement may use the treble component of the speech component of the high-quality microphone's input to improve the overall audio quality of speech in the audio.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
initiating an audio interaction;
predicting a change in network connectivity within the audio interaction;
in response to the predicted change in network connectivity, determining whether to perform a voice clarity improvement; and
in response to determining to perform the voice clarity improvement, performing the voice clarity improvement for the audio interaction.

2. The method of claim 1, wherein the predicting is performed using a process of machine learning.

3. The method of claim 1, wherein the voice clarity improvement comprises an improvement using generative adversarial networking.

4. The method of claim 1, wherein the voice clarity improvement comprises supplementing a first voice input with further voice input from one or more connected devices.

5. The method of claim 1, wherein the voice clarity improvement uses both generative adversarial networking and connected devices concurrently.

6. The method of claim 1, wherein the predicting is performed based on a speed and a direction of a moving device.

7. The method of claim 6, wherein the predicting is performed based on a projection that the moving device will enter an area with poor network connectivity.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
initiating an audio interaction;
predicting a change in network connectivity within the audio interaction;
in response to the predicted change in network connectivity, determining whether to perform a voice clarity improvement; and
in response to determining to perform the voice clarity improvement, performing the voice clarity improvement for the audio interaction.

9. The computer system of claim 8, wherein the predicting is performed using a process of machine learning.

10. The computer system of claim 8, wherein the voice clarity improvement comprises an improvement using generative adversarial networking.

11. The computer system of claim 8, wherein the voice clarity improvement comprises supplementing a first voice input with further voice input from one or more connected devices.

12. The computer system of claim 8, wherein the voice clarity improvement uses both generative adversarial networking and connected devices concurrently.

13. The computer system of claim 8, wherein the predicting is performed based on a speed and a direction of a moving device.

14. The computer system of claim 13, wherein the predicting is performed based on a projection that the moving device will enter an area with poor network connectivity.

15. A computer program product, the computer program product comprising:
one or more computer-readable tangible storage medium and program instructions stored on at least one of the one or more tangible storage medium, the program instructions executable by a processor capable of performing a method, the method comprising:
initiating an audio interaction;
predicting a change in network connectivity within the audio interaction;
in response to the predicted change in network connectivity, determining whether to perform a voice clarity improvement; and
in response to determining to perform the voice clarity improvement, performing the voice clarity improvement for the audio interaction.

16. The computer program product of claim 15, wherein the predicting is performed using a process of machine learning.

17. The computer program product of claim 15, wherein the voice clarity improvement comprises an improvement using generative adversarial networking.

18. The computer program product of claim 15, wherein the voice clarity improvement comprises supplementing a first voice input with further voice input from one or more connected devices.

19. The computer program product of claim 15, wherein the voice clarity improvement uses both generative adversarial networking and connected devices concurrently.

20. The computer program product of claim 15, wherein the predicting is performed based on a speed and a direction of a moving device.
